(19) United States
(12) Patent Application Publication
(10) Pub. No.: US 2009/0060483 A1
(43) Pub. Date: Mar. 5, 2009

(54) Underwater Monitoring System with Automatic Cleaning Capability

(75) Inventors: Kuen-Yu Huang, Chu-Pei City (TW); Yao-Tsung Wang, Lu-Chu Hsiang (TW); Fang-Pang Lin, Hsinchu City (TW); Jo-Yu Chang, Feng-Shan City (TW)

Correspondence Address: BINGHAM MCCUTCHEN LLP, Three Embarcadero Center, San Francisco, CA, 94111-4067, US

(73) Assignee: NATIONAL APPLIED RESEARCH LABORATORIES, Taipei City (TW)

(21) Appl. No.: 11/965,508

(22) Filed: Dec. 27, 2007

(30) Foreign Application Priority Data
Aug. 30, 2007 (TW) 096132226

(51) Int. Cl. G03B 17/08

(52) U.S. Cl. 396/26

(57) ABSTRACT

An underwater monitoring system with an automatic cleaning capability includes abase, a monitoring device mounted on the base, and a water-flow forming device mounted on the base and operable to form and direct a water flow toward the monitoring device for cleaning the monitoring device. The water-flow forming device includes a pressurizing pump for forming the water flow, such as a laminar flow, and a controller coupled electrically to the pressurizing pump for controlling activation and deactivation of the pressurizing pump.

### CROSS-REFERENCE TO RELATED APPLICATION

This application claims priority of Taiwanese application no. 096132226, filed on Aug. 30, 2007.

### BACKGROUND OF THE INVENTION

1. Field of the Invention

The invention relates to an underwater monitoring system, more particularly to an underwater monitoring system with an automatic cleaning capability.

2. Description of the Related Art

For electronic equipments used underwater for long periods of time, such as light sensors, underwater cameras, etc., apart from waterproof and corrosion-resistant requirements, it is also required to take into consideration growth and accumulation of underwater plants and creatures thereon. In case of uncontrolled growth and accumulation of underwater plants and creatures on a lens of an underwater camera or a sensing portion of a light sensor, data gathered by such electronic equipments will be distorted or erroneous. Moreover, the underwater plants and creatures (such as algae) may degrade the waterproof structure of such electronic equipments and eventually enter into the same, thereby destroying the equipments.

To avoid occurrence of the aforesaid situations, a conventional measure is to deploy diving personnel to periodically clean the equipments. However, due to the rapid growth of underwater plants and creatures, the cleaning operation must be conducted frequently, thereby resulting in huge maintenance costs.

### SUMMARY OF THE INVENTION

Therefore, the object of the present invention is to provide an underwater monitoring system with an automatic cleaning capability to overcome the aforesaid drawbacks of the prior art.

Accordingly, an underwater monitoring system of the present invention comprises a base, a monitoring device mounted on the base, and a water-flow forming device mounted on the base and operable to form and direct a water flow toward the monitoring device for cleaning the monitoring device.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the first preferred embodiment of an underwater monitoring system with an automatic cleaning capability according to the present invention in a state of use;

FIG. 2 is a schematic diagram illustrating a water flow formed by a water-flow forming device of the first preferred embodiment; and

FIG. 3 is a perspective view of the second preferred embodiment of an underwater monitoring system with an automatic cleaning capability according to the present invention in a state of use.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

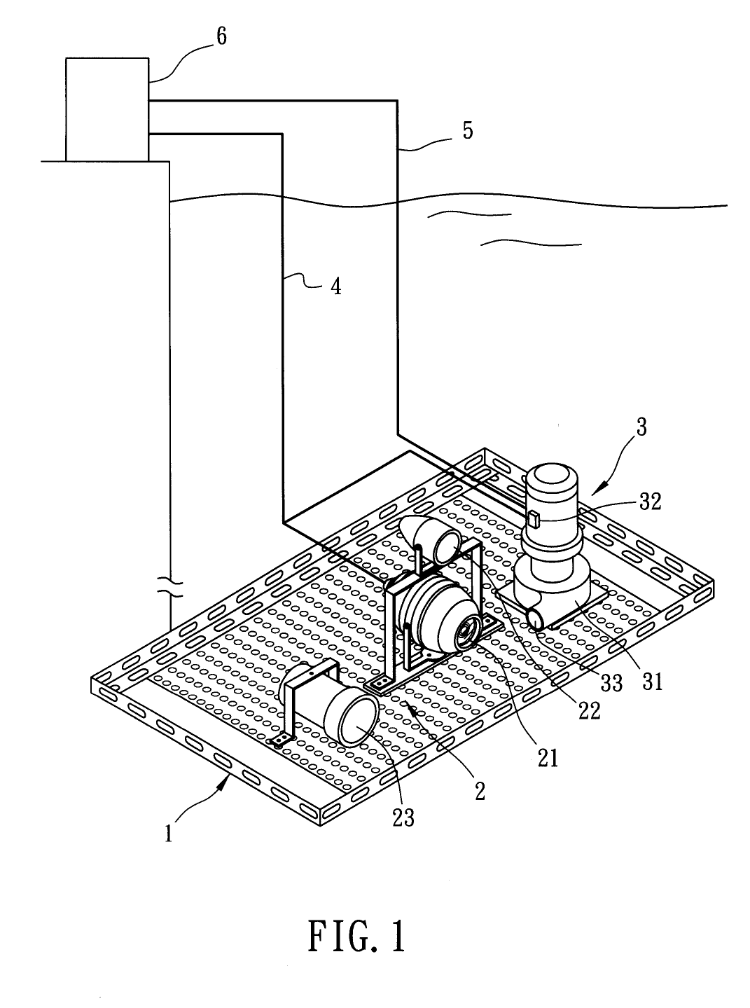

Referring to FIG. 1, the first preferred embodiment of an underwater monitoring system with an automatic cleaning capability according to the present invention is adapted to be disposed on an ocean bed and includes: a base 1; a monitoring device 2 mounted on the base 1; and a water-flow forming device 3 mounted on the base 1 and operable to form and direct a water flow toward the monitoring device 2 for cleaning the monitoring device 2.

The base 1 is mounted fixedly on an ocean bed in an area targeted for observation and is used as a platform for mounting the monitoring device 2 and the water-flow forming device 3 thereon.

The monitoring device 2 includes an underwater camera 21, an infrared light illumination module 22, and a visible light illumination module 23, all mounted on the base 1. The infrared light illumination module 22 and the visible light illumination module 23 are used to assist the underwater camera 21 for nocturnal monitoring and observation. While only one underwater camera 21 is used in this embodiment, the monitoring device 2 can include other types of monitoring devices, such as a light sensor, depending on requirements, or can include more than one underwater camera 21 in other embodiments of this invention.

The water-flow forming device 3 includes a pressurizing pump 31 for forming the water flow, and a controller 32 coupled electrically to the pressurizing pump 31 for controlling activation and deactivation of the pressurizing pump 31. In this embodiment, the controller 32 is configured or programmed to periodically activate and deactivate the pressurizing pump 31. In practice, the controller 32 may as well be remotely controllable to activate and deactivate the pressurizing pump 31. Since implementation of the controller 32 can be readily appreciated by those skilled in the art, further details of the same are omitted herein for the sake of brevity.

The monitoring device 2 and the water-flow forming device 3 of the underwater monitoring system are connected electrically to a cable 4. The cable 4 is responsible for providing electric power to the monitoring device 2 and the water-flow forming device 3, and for signal transmission between the underwater camera 21 of the monitoring device 2 and a monitoring station 6 disposed on land. Since the feature of this invention does not reside in how communication and control are established between the underwater camera 21 and the monitoring station 6, further details of the same are omitted herein for the sake of brevity. In this embodiment, the underwater monitoring system further comprises a water pipe 5 adapted for connecting the pressurizing pump 31 to a water source.

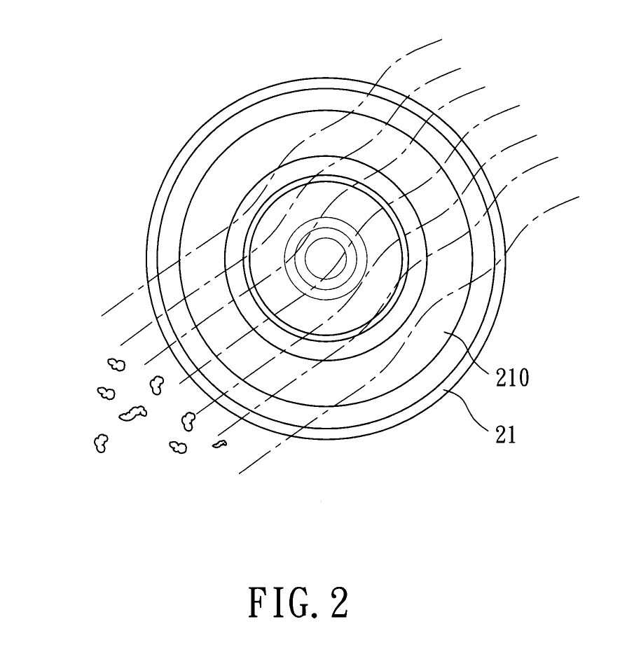

As shown in FIGS. 1 and 2, the pressurizing pump 31 has a water discharge outlet 33 directed toward a camera lens 210 of the underwater camera 21 such that, when the pressurizing pump 31 is activated, a laminar flow (shown in dashed lines in FIG. 2) is formed by the pressurizing pump 31 from water supplied via the water pipe 5 and is able to flow over a surface of the camera lens 210, thereby removing underwater plants and creatures on the surface of the camera lens 210 so as to avoid the adverse effects associated with the growth and accumulation of underwater plants and creatures on the cameral lens 210.

According to experimental results, subjecting the camera lens 210 of the underwater camera 21 to a laminar flow for ten to fifteen minutes per day is sufficient to prevent growth and accumulation of underwater plants and creatures on the camera lens 210.

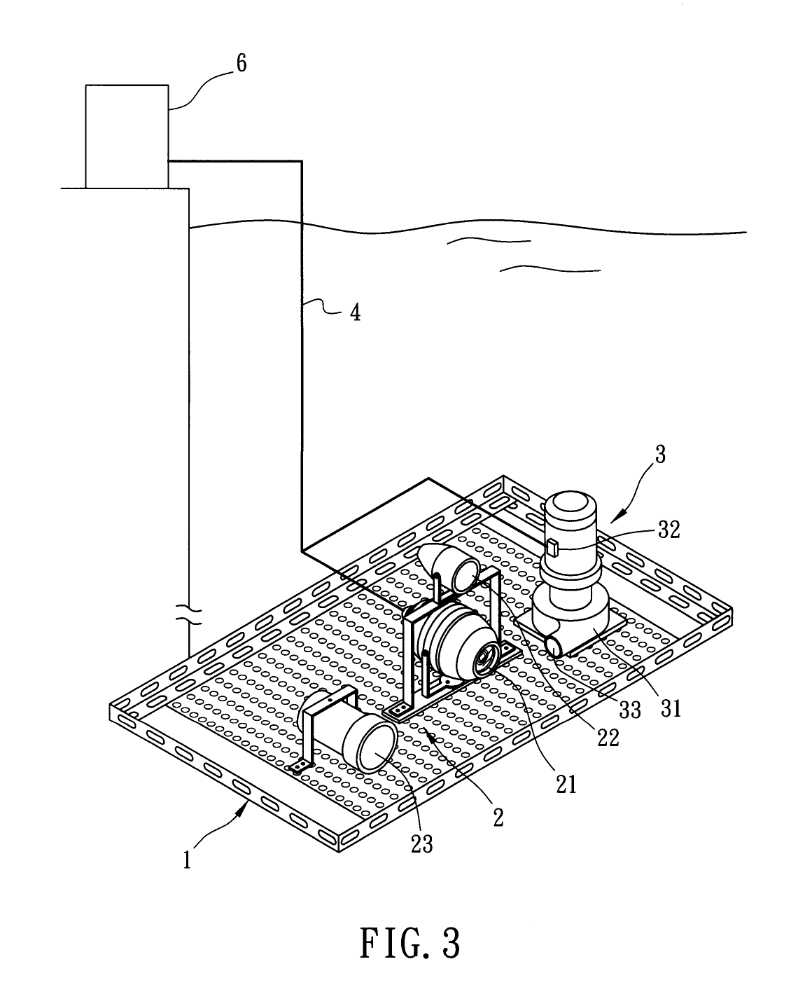

FIG. 3 illustrates the second preferred embodiment of this invention, which differs from the first preferred embodiment in that the pressurizing pump 31 is not connected to a water pipe 5 for obtaining water therefrom. Instead, the pressurizing pump 31 is adapted to draw water (for instance, ocean water in this embodiment) from an environment where the underwater monitoring system is submerged.

In sum, the underwater monitoring system of this invention uses water flow artificially formed by the water-flow forming device 3 to prevent growth and accumulation of underwater plants and creatures on the monitoring device 2.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An underwater monitoring system comprising:
a base;
a monitoring device mounted on said base; and
a water-flow forming device mounted on said base and operable to form and direct a water flow toward said monitoring device for cleaning said monitoring device.

2. The underwater monitoring system as claimed in claim 1, wherein said water-flow forming device includes a pressurizing pump for forming the water flow, and a controller coupled electrically to said pressurizing pump for controlling activation and deactivation of said pressurizing pump.

3. The underwater monitoring system as claimed in claim 2, wherein the water flow formed by said pressurizing pump is a laminar flow.

4. The underwater monitoring system as claimed in claim 3, further comprising a water pipe adapted for connecting said pressurizing pump to a water source.

5. The underwater monitoring system as claimed in claim 3, wherein said pressurizing pump is adapted to draw water from an environment where said underwater monitoring system is submerged.

6. The underwater monitoring system as claimed in claim 3, wherein said monitoring device includes an underwater camera with a camera lens.

7. The underwater monitoring system as claimed in claim 6, wherein said pressurizing pump has a water discharge outlet directed toward said camera lens of said underwater camera such that the laminar flow from said pressurizing pump is able to flow over a surface of said camera lens.

8. The underwater monitoring system as claimed in claim 6, wherein said monitoring device further includes at least one of an infrared light illumination module and a visible light illumination module.

9. The underwater monitoring system as claimed in claim 2, wherein said controller is configured to periodically activate and deactivate said pressurizing pump.

10. The underwater monitoring system as claimed in claim 2, wherein said controller is remotely controllable to activate and deactivate said pressurizing pump.
